(19) United States
(12) Patent Application Publication
(10) Pub. No.: US 2021/0013465 A1
(43) Pub. Date: Jan. 14, 2021

(54) POWER STORAGE MODULE

(71) Applicant: HONDA MOTOR CO., LTD., Tokyo (JP)

(72) Inventor: Atsushi Sakurai, Wako-shi (JP)

(21) Appl. No.: 16/912,858

(22) Filed: Jun. 26, 2020

(30) Foreign Application Priority Data
Jul. 10, 2019 (JP) 2019-128292

(51) Int. Cl. H01M 2/10; H01M 10/6554; H01M 10/613; H01M 10/625; H01M 10/647

(52) U.S. Cl. CPC H01M 2/1077; H01M 10/6554; H01M 2220/20; H01M 10/625; H01M 10/647; H01M 10/613

(57) ABSTRACT

What is provided is a power storage module (1) including a cell housing body (2) having a rectangular top plate (21) and bottom plate (22), and two rectangular side plates (23 and 23) disposed to face each other to connect the top plate (21) and the bottom plate (22), a plurality of cell housing spaces (27) disposed in the cell housing body (2) and separated by a partition plate (26) connecting the two side plates (23 and 23), a power storage cell (3) housed in the cell housing spaces (27), and plate-shaped flange portions (25 and 25) formed to protrude from outer surfaces of the two side plates (23 and 23), wherein the power storage module (1) is fixable to an installation site by fixing the plate-shaped flange portions (25 and 25) to the installation site.

### BACKGROUND OF THE INVENTION

### Field of the Invention

The present invention relates to a power storage module.

Priority is claimed on Japanese Patent Application No. 2019-128292 filed in Japan on Jul. 10, 2019, the content of which is incorporated herein by reference.

### Description of Related Art

A power storage module is mounted on hybrid cars, electric vehicles, or the like. A power storage module is configured by stacking a plurality of power storage cells. The power storage cells each include a battery element having a positive electrode and a negative electrode.

For example, Patent Document 1 describes a power storage module including a storage battery group in which a plurality of storage batteries are stacked, end plates provided at both ends in the stacking direction of the storage battery group, a connecting band that connects the end plates, a fastening member housing portion positioned inside the connecting band to be provided directly on or adjacent to the end plates and housing a pair of fastening members that fix the power storage module to an installation site, and a heat sink in contact with the storage battery group and disposed between the pair of fastening members extending from the fastening member housing portion.

Also, Patent Document 2 describes a battery module fixing structure in which a battery module including a cell stack formed by stacking a plurality of cells in a front-rear direction and having a front surface, a rear surface, a left surface, a right surface, an upper surface, and a lower surface, end plates disposed on the front surface and the rear surface of the cell stack, and side plates disposed on the left surface and the right surface of the cell stack is fixed to a module fixing plate on which the battery module is mounted.

### PATENT DOCUMENTS

Patent Document 1: Japanese Patent No. 6254904

Patent Document 2: Japanese Patent No. 6310989

### SUMMARY OF THE INVENTION

However, the conventional power storage module has a problem in that a cell housing body is deformed when power storage cells disposed in the cell housing body expand due to charging and discharging. When the cell housing body is deformed, in a case in which the power storage module is fixed to an installation site by fixing the cell housing body to the installation site of the power storage module, it is difficult to remove the power storage module from the installation site and then fix it thereto again. Therefore, in the conventional power storage module, it has been required to curb deformation of the cell housing body which is caused due to expansion of power storage cells disposed in the cell housing body.

The present invention has been made in view of the above circumstances, and an objective of the present invention is to provide a power storage module in which a cell housing body is not easily deformed even when power storage cells disposed in the cell housing body expand.

In order to achieve the above-described objective, a first aspect of the present invention provides the following method.

(1) A power storage module including a cell housing body having, a rectangular top plate and bottom plate, and two rectangular side plates disposed to face each other to connect the top plate and the bottom plate, a plurality of cell housing spaces disposed in the cell housing body and separated by a partition plate connecting the two side plates, a power storage cell housed in the cell housing spaces, and plate-shaped flange portions formed to protrude from outer surfaces of the two side plates, wherein the power storage module is fixable to an installation site by fixing the plate-shaped flange portions to the installation site.

A second aspect of the present invention provides the following method.

(2) A power storage module including a cell housing body having a rectangular top plate and bottom plate, and two rectangular side plates disposed to face each other to connect the top plate and the bottom plate, a cell housing space disposed in the cell housing body, a power storage cell housed in the cell housing space, and plate-shaped flange portions formed to protrude from outer surfaces of the two side plates, wherein connecting portions connecting the top plate and the bottom plate to the two side plates are each provided on a side outward from an extended surface of an inner wall surface of each of the side plates, and the power storage module is fixable to an installation site by fixing the plate-shaped flange portions to the installation site.

The first aspect and the second aspect of the present invention preferably include the following features. In the following features, it is also preferable to combine two or more features.

(3) The power storage module according to the aspect (1) or (2) described above, in which the flange portions are disposed parallel to the top plate and the bottom plate over an entire length of the side plates in a length direction, and attachment portions which fix the flange portions to the installation site are provided at a plurality of positions in an extending direction of the flange portions.

(4) The power storage module according to any one of the aspects (1) to (3) described above, in which the cell housing body is an integrally molded product which is formed by impact-molding or extrusion-molding a metal material.

(5) The power storage module according to any one of the aspects (1) to (4) described above, in which a sheet-shaped elastic member is disposed in the cell housing space together with the power storage cell.

(6) The power storage module according to the aspect (5) described above in which the sheet-shaped elastic member includes an elastic body or a structure body having expansibility, and a housing bag in which the elastic body or the structure body having expansibility is housed, and the housing bag is formed of a metal foil composite laminate film.

(7) The power storage module according to any one of the aspects (1) to (6) described above, in which one or both of the top plate and the bottom plate include a refrigerant flow path in which a refrigerant flows.

(8) The power storage module according to the aspect (7) described above in which the cell housing body includes two openings surrounded by the top plate, the bottom plate, and the two side plates, an inlet port for injecting the refrigerant into the refrigerant flow path and a discharge port for discharging the refrigerant that has passed through the refrigerant flow path are provided in the vicinity of one of the two openings, and a positive electrode terminal and a negative electrode terminal of the power storage cell are disposed at one of the two openings which is distant from the inlet port and the discharge port.

(9) The power storage module according to any one of the aspects (1) to (8) described above, in which the power storage cell is a cell which is formed by enclosing a battery element in a laminate film.

(10) The power storage module according to any one of the aspects (1) to (9) described above, in which a plurality of power storage cells are disposed to be stacked between the top plate and the bottom plate.

The power storage module of the first aspect and the power storage module of the second aspect may mutually share their preferable characteristics, unless there is a problem.

According to the present invention, a power storage module in which a cell housing body is not easily deformed even when power storage cells disposed in the cell housing body expand can be provided.

### BRIEF DESCRIPTION OF THE DRAWINGS

FIG. 1 is a schematic perspective view illustrating a preferred example of a power storage module according to an embodiment of the present invention.

FIG. 2 is a schematic cross-sectional view of the power storage module illustrated in FIG. 1 taken along line A-A.

FIG. 3 is a schematic perspective view illustrating only a cell housing body of the power storage module illustrated in FIG. 1.

FIG. 4 is a schematic view which is used to explain a state in which power storage cells and an elastic member are housed in a cell housing space of the power storage module illustrated in FIG. 1.

FIG. 5 is an enlarged schematic cross-sectional view illustrating a part of a cut surface of the power storage module illustrated in FIG. 1 taken along line A-A and is an explanation view which is used to explain a state of the cell housing body when the power storage cells expand in the cell housing space.

FIG. 6 is an explanatory view which is used to explain a state of the cell housing body when the power storage cells expand in the cell housing space in a case in which a partition plate is not provided in the power storage module illustrated in FIG. 1 and is an enlarged schematic cross-sectional view illustrating a part of a cut surface taken at a position corresponding to the line A-A of the power storage module illustrated in FIG. 1.

FIG. 7 is a schematic perspective view illustrating an example of a power storage module according to another embodiment of the present invention.

FIG. 8 is a schematic cross-sectional view of the power storage module illustrated in FIG. 7 taken along line B-B.

FIG. 9 is an enlarged schematic cross-sectional view in which a part of FIG. 8 is enlarged.

FIG. 10 is an enlarged schematic cross-sectional view illustrating a part of a cut surface of the power storage module illustrated in FIG. 7 taken along line B-B and is an explanatory view which is used to explain a state of a cell housing body when power storage cells expand in the cell housing space.

FIG. 11 is a schematic cross-sectional view illustrating an example of a power storage module according to still another embodiment of the present invention.

FIG. 12 is a schematic cross-sectional view illustrating an example of a power storage module according to yet another embodiment of the present invention.

FIG. 13 is a cross-sectional view illustrating other examples of connecting portions of the power storage module.

### DETAILED DESCRIPTION OF THE INVENTION

Hereinafter, a power storage module of the present invention will be described in detail with reference to the drawings. In the drawings used in the following description, there are cases in which characteristic portions are appropriately enlarged for convenience of illustration so that characteristics of the present invention can be easily understood. Therefore, dimensions and proportions of respective constituent elements may be different from actual ones. Materials, dimensions, and the like provided in the following description are merely examples. Accordingly, the present invention is not limited only to the embodiments described below and can be appropriately changed and implemented within a scope not changing the requirements of the present invention.

### First Embodiment

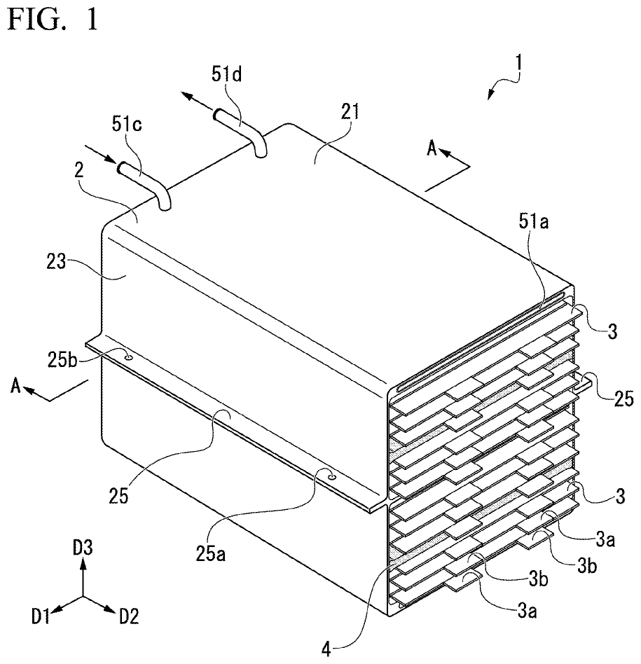

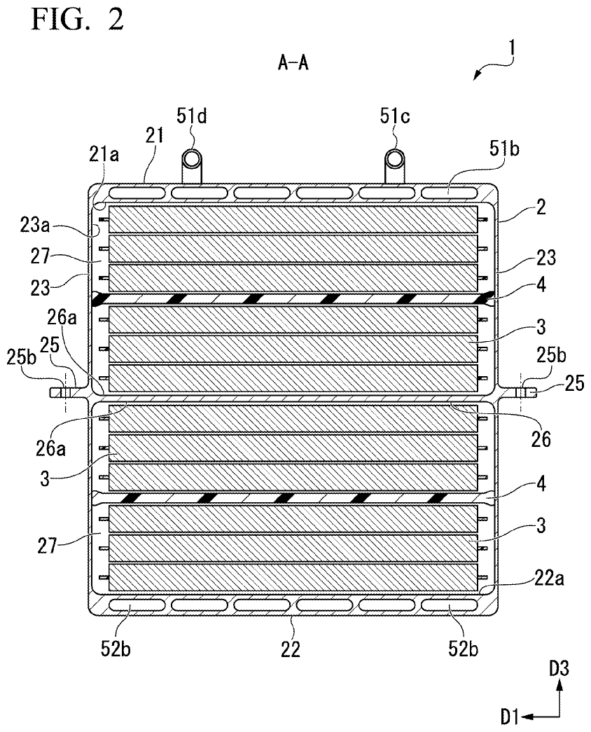

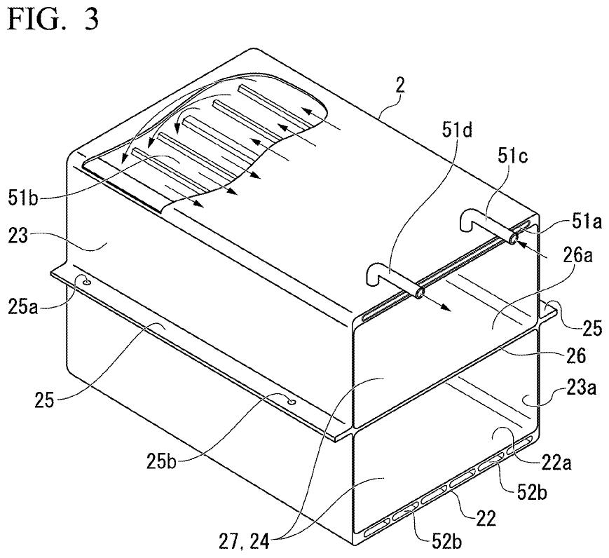

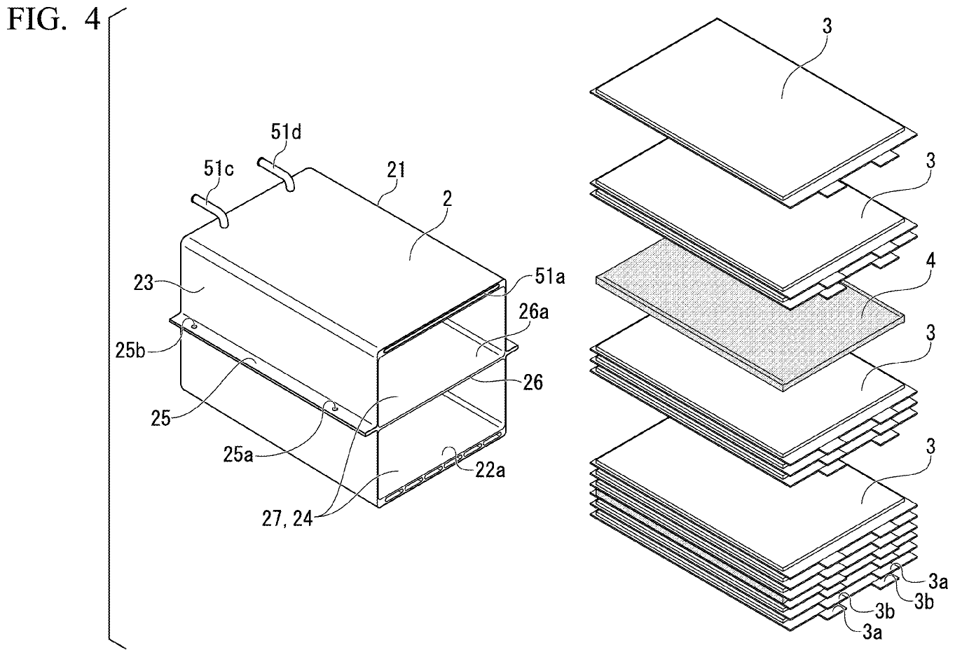

FIG. 1 is a perspective view illustrating a power storage module according to an embodiment of the present invention. FIG. 2 is a cross-sectional view of the power storage module illustrated in FIG. 1 taken along line A-A. FIG. 3 is a perspective view illustrating only a cell housing body of the power storage module illustrated in FIG. 1. FIG. 4 is a view which explains a state in which a power storage cell and an elastic member are housed in a cell housing space of the power storage module illustrated in FIG. 1.

A power storage module 1 according to the present embodiment includes a cell housing body 2, a plurality (two in the present embodiment) of cell housing spaces 27 and 27 disposed in the cell housing body 2, a power storage cell 3 and an elastic member 4 housed in the cell housing spaces 27 and 27, and flange portions 25 and 25 to be fixed to an installation site of the power storage module 1.

In the present embodiment, the power storage module 1 is fixed to the installation site to be installed by fixing the flange portions 25 to the installation site (not illustrated) of the power storage module 1.

In directions illustrated in the drawings, a D1 direction indicates a width direction of the cell housing body 2. A D2 direction indicates a length direction of the cell housing body 2. A D3 direction indicates a height direction of the cell housing body 2. A direction indicated by the D3 direction is upward with respect to the direction of gravity.

The cell housing body 2 has a rectangular cylindrical shape. The cell housing body 2 includes a rectangular top plate 21 and bottom plate 22 which are long in the D2 direction, two rectangular side plates 23 and 23 disposed at both ends in the D1 direction and facing each other to connect the top plate 21 and the bottom plate 22, two rectangular openings 24 and 24 surrounded by the top plate 21, the bottom plate 22, and the two side plates 23 and 23, the plate-shaped flange portions 25 and 25 formed to protrude from outer surfaces of the two side plates 23 and 23, and a partition plate 26 which partitions the inside of the cell housing body 2.

Connecting portions connecting the top plate 21 and the bottom plate 22 to the two side plates 23 and 23 in the cell housing body 2 are each formed by one curved surface that is curved with a predetermined curvature as illustrated in FIGS. 2 and 3.

One partition plate 26 is provided inside the cell housing body 2. As illustrated in FIG. 4, the partition plate 26 is integrally provided to connect between inner wall surfaces 23a and 23a of the side plates 23 facing each other. The partition plate 26 extends over the entire length in the D1 direction and the D2 direction of the cell housing body 2. Wall surfaces 26a and 26a of the partition plate 26 are parallel to an inner wall surface 21a of the top plate 21 and an inner wall surface 22a of the bottom plate 22.

The partition plate 26 is disposed at a position that equally divides a space between the inner wall surface 21a of the top plate 21 and the inner wall surface 22a of the bottom plate 22. Deformation of the side plates 23 and 23 according to expansion of the power storage cell 3 tends to increase closer to centers of the side plates 23 and 23. In the present embodiment, since the partition plate 26 is provided at substantially a central position on the side plates 23 and 23 in the height direction of the cell housing body 2, deformation of the side plates 23 according to the expansion of the power storage cell 3 can be effectively curbed.

As illustrated in FIGS. 1 to 4, in the present embodiment, the inside of the cell housing body 2 is separated into two cell housing spaces 27 and 27 by the partition plate 26. In other words, the cell housing spaces 27 and 27 are separately formed inside the cell housing body 2 between the inner wall surface 21a of the top plate 21 and the wall surface 26a of the partition plate 26, and the inner wall surface 22a of the bottom plate 22 and the wall surface 26a of the partition plate 26.

In the present embodiment, although the case in which the two cell housing spaces 27 and 27 are disposed by providing one partition plate 26 inside the cell housing body 2 has been described as an example, the number of partition plates (in other words, the number of cell housing spaces) disposed inside the cell housing body is not limited to one (the number of cell housing spaces is two), and may be two or more (the number of cell housing spaces is three or more), and can be appropriately determined according to applications of the power storage module 1.

As illustrated in FIGS. 1 to 4, the flange portions 25 and 25 are provided integrally with the cell housing body 2. The flange portions 25 and 25 are formed to protrude in the D1 direction from the side plates 23 and 23. In the present embodiment, the flange portions 25 and 25 are disposed parallel to the top plate 21 and the bottom plate 22 over the entire length of the side plates 23 and 23 in the length direction.

Positions in the height direction of the cell housing body 2 at which the flange portions 25 and 25 are provided are preferably close to a position at which the partition plate 26 is provided. In the vicinity of the positions on the side plates 23 and 23 at which the partition plate 26 is provided, deformation of the side plates 23 according to expansion of the power storage cell 3 is effectively curbed by the partition plate 26. Also, since the vicinity of the positions on the side plates 23 and 23 at which the flange portions 25 and 25 are provided has a high rigidity due to the provided flange portions 25 and 25, deformation of the side plates 23 according to expansion of the power storage cell 3 does not easily occur. When positions in the height direction of the cell housing body 2 at which the flange portions 25 and 25 are provided and positions in the height direction of the cell housing body 2 at which the partition plate 26 is provided are close to each other, a synergistic effect in curbing deformation of the side plates 23 is obtained by the partition plate 26 and the flange portions 25 and 25. Therefore, deformation of the side plate 23 at the positions at which the flange portions 25 and 25 are provided is more effectively prevented.

When only one partition plate 26 is provided as illustrated in FIGS. 1 to 4, positions on the side plates 23 and 23 at which the flange portions 25 and 25 are provided may be closer to the top plate 21 than the partition plate 26 is as illustrated in FIG. 2 or may be closer to the bottom plate 22 than the partition plate 26 is.

Also, positions of the flange portions 25 and 25 and the partition plate 26 in the height direction of the cell housing body 2 may be different from each other as illustrated in FIG. 2 or may be the same as each other.

As illustrated in FIGS. 1 to 4, attachment portions 25a and 25b are provided at a plurality of positions (two in the present embodiment) in an extending direction of each of the flange portions 25 and 25. The attachment portions 25a and 25b are for fixing the flange portions 25 and 25 to the installation site of the power storage module 1. As illustrated in FIGS. 1 to 4, the attachment portions 25a and 25b may be made as, for example, through holes to which fixing members such as bolts are attached.

In the present embodiment, the attachment portions 25a and 25b are respectively provided in the vicinity of end portions in the extending direction of the flange portions 25 and 25. Since the power storage cell 3 expands more closer to a central portion, deformation of the side plates 23 and 23 according to the expansion of the power storage cell 3 tends to increase closer to the central portion. Therefore, when the attachment portions 25a and 25b are respectively provided in the vicinity of the end portions in the extending direction of the flange portions 25 and 25, positional deviation between the installation site of the power storage module 1 and the attachment portions 25a and 25b due to the deformation of the side plates 23 and 23 is smaller compared to that in a case in which the attachment portions are provided at the center in the extending direction of the flange portions 25 and 25. Therefore, when the attachment portions 25a and 25b are respectively provided in the vicinity of the end portions in the extending direction of the flange portions 25 and 25, problems caused by the positional deviation between the installation site of the power storage module 1 and the attachment portions 25a and 25b do not easily occur, and thus this is desirable.

In the cell housing body 2, all of the top plate 21, the bottom plate 22, the side plates 23, the flange portion 25, and the partition plate 26 are preferably formed of a metal material with good heat conductivity such as aluminum or an aluminum alloy. The cell housing body 2 can be made as an integrally molded product by impact molding or extrusion molding in the D2 direction.

When the cell housing body 2 in the present embodiment is an integrally molded product made of a metal material, since heat conductivity thereof is good, temperatures of the partition plate 26 and an outer surface of the cell housing body 2 are made uniform. As a result, increase in temperature of the power storage cell 3 is curbed, and expansion of the power storage cell 3 according to the increase in the temperature of the power storage cell 3 is more effectively curbed. Also, when the cell housing body 2 of the present embodiment is an integrally molded product made of a metal material, the cell housing body 2 has a satisfactory strength. Also, when the cell housing body 2 is an integrally molded product, since it is not necessary to assemble separately formed parts to form the cell housing body 2, the number of parts of the cell housing body 2 can be reduced and the productivity is excellent.

In the power storage module 1 illustrated in the present embodiment, the top plate 21 includes a refrigerant flow path 51b (see FIGS. 2 and 3) in which a refrigerant flows, and sealing plates 51a provided at both ends in an extending direction of the refrigerant flow path 51b to seal the refrigerant flow path 51b. As illustrated in FIGS. 2 and 3, a plurality (six in the present embodiment) of refrigerant flow paths 51b are provided to extend in the length direction (D2 direction) of the cell housing body 2. As illustrated in FIG. 3, all the refrigerant flow paths 51b join together at one end portion of the top plate 21 in the length direction (D2 direction) of the cell housing body 2. Also, the refrigerant flow paths 51b having the same flow direction of the refrigerant join together at the other end portion of the top plate 21 in the length direction (D2 direction) of the cell housing body 2.

The top plate 21 is preferably formed by a method of impact molding or extrusion molding in the D2 direction as a part of the cell housing body 2. Specifically, holes serving as the refrigerant flow paths 51b are provided in an entire region in the length direction (D2 direction) of the cell housing body 2 by a method of impact molding or extrusion molding in the D2 direction as a part of the cell housing body 2. Thereafter, walls partitioning adjacent holes are removed so that all the refrigerant flow paths 51b join together at one end portion in the D2 direction of the top plate 21. Also, of the walls partitioning adjacent holes, walls of the refrigerant flow paths 51b having the same refrigerant flow direction are removed so that the refrigerant flow paths 51b having the same flow direction of the refrigerant join together at the other end portion in the D2 direction of the top plate 21. Thereafter, the sealing plates 51a are installed at both ends in the extending direction of the refrigerant flow path 51b.

As the refrigerant, a liquid such as water or a gas such as air, carbon dioxide, or nitrogen can be used, and it is preferable to use water. By using water as the refrigerant, it is possible to cool efficiently. A planar shape of the refrigerant flow path 51b is not particularly limited and can be appropriately determined according to heat transfer efficiency from the top plate 21 to the cell housing spaces 27.

In the present embodiment, an inlet port 51c for injecting a refrigerant into the refrigerant flow paths 51b of the top plate 21, and a discharge port 51d for discharging the refrigerant that has passed through the refrigerant flow paths 51b are provided in the vicinity of one of the two openings 24 and 24 of the cell housing body 2.

As illustrated in FIG. 3, the inlet port 51c and the discharge port 51d are provided in the vicinity of an end portion on a side (front side in FIG. 3) in which the refrigerant flow paths 51b having the same flow direction of the refrigerant join together in the length direction (D2 direction) of the cell housing body 2 in the top plate 21.

In the power storage module 1 of the present embodiment, when the refrigerant is caused to flow through the refrigerant flow paths 51b of the top plate 21, the insides of the cell housing spaces 27 are cooled via the top plate 21. As a result, in the power storage module 1 of the present embodiment, expansion of the power storage cell 3 according to the increase in temperature of the power storage cell 3 is more effectively curbed.

Also, in the power storage module 1 according to the present embodiment, when the bottom plate 22 is formed of a metal plate, the bottom plate 22 functions as a heat dissipation plate, and also functions as a heat transfer path between the top plate 21 in which the refrigerant is caused to flow and the power storage cell 3. Therefore, increase in temperature of the power storage cell 3 is curbed, and expansion of the power storage cell 3 according to the increase in the temperature of the power storage cell 3 is further curbed, and thus this is desirable.

It is preferable that one or more holes 52b extending in a direction substantially perpendicular to a thickness direction (D3 direction) be provided inside the bottom plate 22. Thereby, further improvement in heat dissipation performance of the bottom plate 22 and further reduction in weight of the power storage module 1 can be achieved. In the present embodiment, as illustrated in FIGS. 2 and 3, six holes 52b having substantially an oval shape in a cross-sectional view, in which a dimension thereof in the thickness direction (D3 direction) of the bottom plate 22 is smaller than a dimension thereof in a surface direction (D1 direction) of the bottom plate 22, are provided to extend in the D2 direction. In the present embodiment, since the holes 52b of the bottom plate 22 extend in the D2 direction, the bottom plate 22 can be molded by a method of impact molding or extrusion molding in the D2 direction as a part of the cell housing body 2, and thus this is desirable.

### Power Storage Cell

As illustrated in FIGS. 1 and 2, a plurality of power storage cells 3 are disposed to be stacked between the top plate 21 and the bottom plate 22. In the present embodiment, the power storage cells 3 are housed in the two cell housing spaces 27 and 27 of the cell housing body 2. A plurality (six in this embodiment) of power storage cells 3 are housed in each of the cell housing spaces 27. Therefore, in the cell housing body 2, a total of 12 power storage cells 3 are distributed and housed in the two cell housing spaces 27.

The power storage cell 3 houses a battery element (not illustrated) having a positive electrode plate and a negative electrode plate inside. As illustrated in FIG. 4, the power storage cell 3 is flat in the D2 direction. The power storage cell 3 has a laterally elongated rectangular shape having a dimension slightly larger than the length of the cell housing space 27 and a width slightly smaller than a width of the cell housing space 27.

In the present embodiment, as illustrated in FIG. 4, a positive electrode terminal 3a and a negative electrode terminal 3b are provided to protrude at one end in the width direction (D2 direction) of the power storage cell 3. The positive electrode terminal 3a is electrically connected to the positive electrode plate of the battery element. Also, the negative electrode terminal 3b is electrically connected to the negative electrode plate of the battery element. As illustrated in FIG. 1, the positive electrode terminal 3a and the negative electrode terminal 3b of the power storage cell 3 are disposed to be aligned in the width direction of the power storage cell 3.

As the power storage cell 3, it is preferable to use one having a laminate pack shape in which the battery element is enclosed in an exterior body made of a laminate film.

As the laminate film, it is preferable to use a metal foil composite laminate film in which a metal foil and a resin film are bonded. As the metal foil composite laminate film, known ones can be used. For example, as the metal foil, one made of a metal such as aluminum, an aluminum alloy, stainless steel, or a nickel alloy can be used. As the resin film, one made of a resin such as polyethylene, ethylene vinyl acetate, or polyethylene terephthalate can be used.

As the power storage cell 3, a power storage cell in which a battery element such as a lithium-ion secondary battery and an electrolytic solution are housed in an exterior body may be used, and a power storage cell in which a battery element formed of an all-solid-state battery having no electrolyte solution is housed in an exterior body may be used.

In the present embodiment, of the openings 24 and 24 of the cell housing body 2, the positive electrode terminal 3a and the negative electrode terminal 3b of the power storage cell 3 are disposed at an opening 24 on a side distant from the inlet port 51c for injecting a refrigerant into the refrigerant flow paths 51b of the top plate 21 and the discharge port 51d for discharging the refrigerant that has passed through the refrigerant flow paths 51b (see FIGS. 1 and 4). The positive electrode terminal 3a and the negative electrode terminal 3b of the power storage cell 3 protrude toward a side outward from the cell housing body 2 from the opening 24.

Therefore, in the power storage module 1 of the present embodiment, the positive electrode terminal 3a or the negative electrode terminal 3b does not become a disturbance when the refrigerant is caused to flow through the refrigerant flow paths 51b of a cooling member 51 using the inlet port 51c and the discharge port 51d, and thus this is desirable. Also, when work of attaching the power storage module 1 of the present embodiment to the installation site of the power storage module 1 or removing it from the installation site is performed, the workability is satisfactory because a likelihood of the refrigerant coming into contact with the positive electrode terminal 3a or the negative electrode terminal 3b is low.

In the present embodiment, as illustrated in FIG. 1, the positive electrode terminals 3a and the negative electrode terminals 3b of adjacent power storage cells 3 and 3 are disposed such that dispositions thereof in the width direction of the power storage cells 3 and 3 are opposite to each other. Therefore, the positive electrode terminals 3a and the negative electrode terminals 3b protruding from the opening 24 of the cell housing body 2 are alternately disposed in the height direction (D3 direction) of the cell housing body 2.

Further, all the power storage cells 3 in the cell housing body 2 may be connected in series or may be connected in parallel.

### Elastic Member

In the power storage module 1 of the present embodiment, as illustrated in FIGS. 1 and 4, one sheet-shaped elastic member 4 is housed in each of the cell housing spaces 27 and 27 together with a plurality (six in the present embodiment) of power storage cells 3. The elastic member 4 is preferably disposed between adjacent power storage cells 3 and 3. In the present embodiment, the elastic member 4 is disposed between the power storage cells 3 and 3 at a center to partition the six power storage cells 3 housed in each cell housing space 27 into two groups.

Similarly to the power storage cell 3, the elastic member 4 is formed in a rectangular sheet shape. The elastic member 4 has a laterally elongated rectangular shape having a dimension slightly larger than the length of the cell housing space 27 and a width slightly larger than the width of the cell housing space 27 (see FIG. 4). As illustrated in FIG. 2, both ends in the width direction (D1 direction) of the elastic member 4 are preferably disposed in contact with the inner wall surfaces 23a of the side plates 23 and 23.

The elastic member 4 is elastically deformable and includes an elastic body or a structure body having expansibility.

As the elastic body used for the elastic member 4, for example, a foamed body made of rubber, a resin, or the like may be used. When an expansion ratio of the foamed body is appropriately set, the foamed body can easily adjust a pressing force against the power storage cells 3 and an absorption status of an expansion force of the power storage cells 3. Also, when the foamed body is used as the elastic member 4, the weight and costs of the power storage module 1 can be further reduced.

As the structure body having a swelling property used for the elastic member 4, for example, it is preferable to use a structure body that swells by being impregnated with a liquid such as a swelling resin or a resin fiber aggregate. As a specific example of the swelling resin, a resin such as PVDF (polyvinylidene fluoride) or a silicone resin can be stated.

As a specific example of the resin fiber aggregate, a laminate of nonwoven fabric made of polyolefin-based resin and/or phenol resin fibers can be stated. As the polyolefin-based resin, polypropylene fibers or the like can be used. When phenol resin fibers are used as the resin fiber aggregate, the elastic member 4 has excellent heat resistance, and thus this is desirable.

When types of the swelling resin, and densities, types, diameters, lengths, shapes, or the like of fibers forming the resin fiber aggregate are appropriately adjusted, the structure body that swells by being impregnated with a liquid can easily adjust a pressing force against the power storage cells 3 and an absorption status of an expansion force of the power storage cells 3. Also, even when the structure body that swells by being impregnated with a liquid is used as the elastic member 4, the weight and costs of the power storage module 1 can be further reduced as in the foamed body.

The elastic member 4 preferably includes an elastic body or a structure body having expansibility, and a housing bag in which the elastic body or the structure body having expansibility is housed. As the housing bag, one that is deformed by a change in shape of the elastic body or the structure body having expansibility is used.

When one in which the structure body that swells by being impregnated with a liquid is housed in the housing bag is used as the elastic member 4, the structure body can be impregnated with a liquid in the housing bag, thereby making it unnecessary to impregnate the structure body with a liquid in the cell housing space 27, and thus this is desirable.

The housing bag is preferably formed of a metal foil composite laminate film in which a metal foil and a resin film are bonded. As the metal foil composite laminate film, known ones can be used. For example, as the metal foil, one made of a metal such as aluminum, an aluminum alloy, stainless steel, or a nickel alloy can be used. As the resin film, one made of a resin such as polyethylene, ethylene vinyl acetate, or polyethylene terephthalate can be used.

When the housing bag is formed of a metal foil composite laminate film, the elastic member 4 can be used as an insulator. Also, in this case, since thermal conductivity of the elastic member 4 is improved, the elastic member 4 can be utilized as a heat transfer path, and this is desirable. For example, as illustrated in FIG. 2, when both ends in the width direction of the elastic member 4 are disposed in contact with the inner wall surfaces 23a of the side plates 23 and 23, the housing bag of the elastic member 4 functions as a heat transfer path between the power storage cell 3 and the side plates 23 and 23. As a result, increase in temperature of the power storage cell 3 is curbed, and expansion of the power storage cell 3 according to the increase in the temperature of the power storage cell 3 is further curbed, thus this is desirable.

When the power storage cells 3 in the cell housing space 27 expand due to charging and discharging, the elastic member 4 is compressed by the expansion force of the power storage cells 3. Thereby, the elastic member 4 reduces a load on the wall surface 26a of each of the partition plate 26, the inner wall surface 21a of the top plate 21, and the inner wall surface 22a of the bottom plate 22 when the power storage cells 3 expand, and the elastic member 4 reduces a load on the cell housing body 2 due to the expansion of the power storage cells 3. As described above, in the present embodiment, since the elastic member 4 is compressed and cancels out a pressing load on the cell housing body 2 which is caused by the expansion of the power storage cells 3, strengths of the wall surface 26a of the partition plate 26, the inner wall surface 21a of the top plate 21, and the inner wall surface 22a of the bottom plate 22 can be set to be low, and thus the weight and costs of the power storage module 1 can be reduced.

### Method of Manufacturing Power Storage Module

Next, a method of manufacturing the power storage module of the present embodiment will be described in detail by taking examples.

First, the cell housing body 2 which is an integrally molded product is manufactured by impact molding or extrusion molding. Also, the power storage cell 3 is manufactured using a conventionally known method.

Next, as illustrated in FIG. 4, the power storage cells 3 and the elastic members 4 are housed to be stacked in the two cell housing spaces 27 disposed in the cell housing body 2. In the present embodiment, three power storage cells 3, an elastic member 4, and three power storage cells 3 are stacked in this order and inserted into each of the cell housing spaces 27 from the openings 24 to be housed therein.

In the present embodiment, when the elastic member 4 and the power storage cells 3 are stacked and housed in the cell housing space 27, these may be housed with the elastic member 4 compressed. In this case, a thickness of the stack of the elastic member 4 and the power storage cells 3 is smaller than a height of the cell housing space 27. Thereby, the stack of the elastic member 4 and the power storage cells 3 can be easily inserted into the cell housing space 27. Therefore, fabrication of the power storage module 1 can be easily and efficiently performed.

Also, when the elastic member 4 is housed in the cell housing space 27 in a compressed state, the elastic member 4 is restored from the compressed state and expands in the cell housing space 27 after the housing. As a result, the six power storage cells 3 and the elastic member 4 in the cell housing space 27 are held without rattling in the cell housing space 27, and thus this is desirable.

With the steps described above, the power storage module 1 of the present embodiment is obtained.

The power storage module 1 of the present embodiment obtained in this way is fixed to a predetermined installation site by fixing the flange portions 25 and 25 to the installation site of the power storage module 1. Specifically, the power storage module 1 is fixed to the installation site by fixing members such as bolts using the attachment portions 25a and 25b provided at a plurality (two in the present embodiment) of positions in the extending direction of the flange portions 25 and 25.

Since the power storage module 1 of the present embodiment includes the cell housing body 2 having the rectangular top plate 21 and bottom plate 22, and the two rectangular side plates 23 and 23 disposed to face each other to connect the top plate 21 and the bottom plate 22, and the partition plate 26 connecting the two side plates 23 and 23 is provided in the cell housing body 2, the cell housing body 2 is not easily deformed even when the power storage cells 3 disposed in the cell housing body 2 expand as will be described below. Therefore, in the power storage module 1 of the present embodiment, work of removing the power storage module 1 from the installation site and then fixing it thereto again can be easily performed.

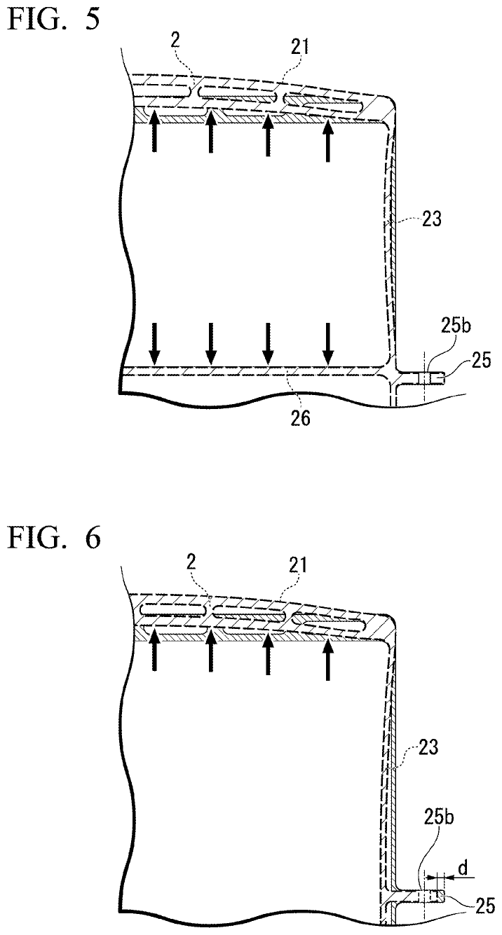

FIG. 5 is an enlarged cross-sectional view illustrating a part of a cut surface obtained by cutting the power storage module illustrated in FIG. 1 taken along line A-A and is an explanatory view which is used to explain a state of the cell housing body when the power storage cells expand in the cell housing space. FIG. 6 is an explanatory view which is used to explain a state of the cell housing body when the power storage cells expand in the cell housing space in a case in which a partition plate is not provided in the power storage module illustrated in FIG. 1 and is an enlarged cross-sectional view illustrating a part of a cut surface taken at a position corresponding to the line A-A of the power storage module illustrated in FIG. 1.

When the power storage cells 3 disposed in the cell housing body 2 expand due to charging and discharging, the inner wall surface 21a of the top plate 21 is pushed outward (upward in FIG. 5) and the top plate 21 is deformed in a convex shape as illustrated by a dotted line in FIG. 5. Since the power storage cells 3 expand more closer to a central portion thereof, deformation of the top plate 21 tends to increase closer to the central portion. Also, due to the expansion force from the power storage cells 3 with respect to the top plate 21, a couple of forces of deforming in a convex shape toward the inside acts on the side plates 23. In the power storage module 1 illustrated in FIG. 1, since the partition plate 26 connecting the two side plates 23 and 23 resists the couple of forces as illustrated in FIG. 5, deformation of the side plates 23 is curbed. Therefore, in the power storage module 1 illustrated in FIG. 1, the cell housing body 2 is not easily deformed even when the power storage cells 3 expand.

On the other hand, in a case in which the partition plate 26 illustrated in FIG. 5 is not provided, when the power storage cells 3 expand, the top plate 21 is deformed in a convex shape, and the side plates 23 are deformed in a convex shape toward the inside by a couple of forces with respect to the expansion force from the power storage cells 3 to the top plate 21 as illustrated by a dotted line in FIG. 6. As a result, a width of the cell housing body 2 is reduced by a dimension d as illustrated in FIG. 6.

When the width of the cell housing body 2 is reduced, the flange portions 25 and 25 fixed to the installation site of the power storage module 1 become difficult to be removed from the installation site. For example, in a case in which the flange portions 25 and 25 are fixed to the installation site by bolts using the attachment portions 25a and 25b formed as through holes, when the width of the cell housing body 2 is reduced, inner walls of the through holes are pressed against shaft portions of the bolts, making it difficult to remove the bolt. Particularly, when the attachment portions are provided at positions close to the center in the extending direction of the flange portions 25 and 25, there are cases in which the cell housing body 2 is greatly deformed, causing the inner wall of the through hole to bite into the bolt, and thus the bolt cannot be removed. Also, when the width of the cell housing body 2 is reduced, in a case in which the power storage module 1 that has been removed from the installation site is fixed again to the installation site, since positions of the attachment portions 25a and 25b of the flange portions 25 and 25 are difficult to be aligned with the installation site, it is difficult to fix them.

### Second Embodiment

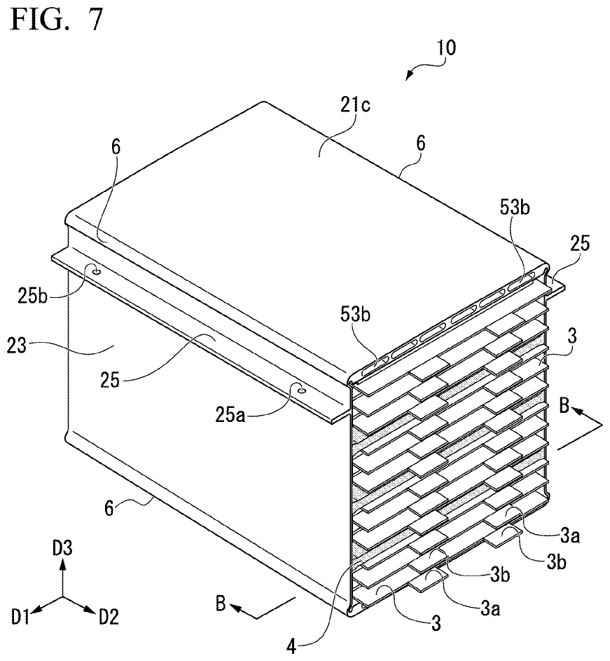

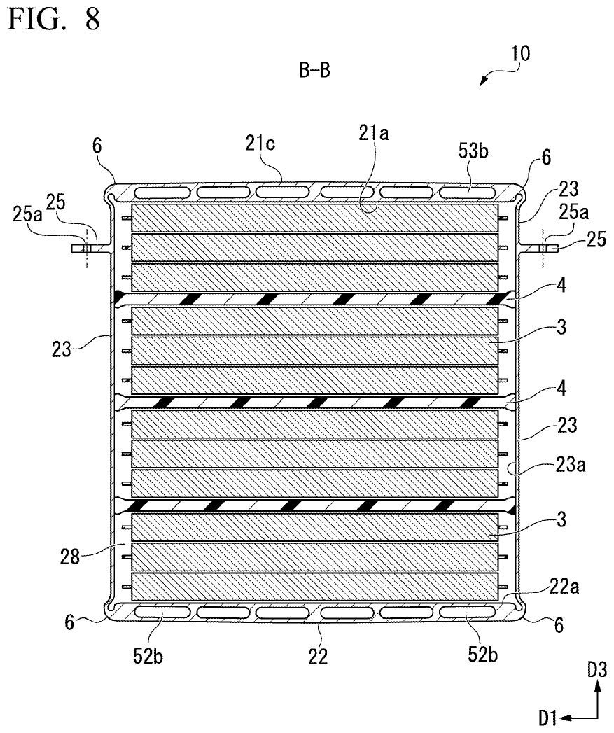

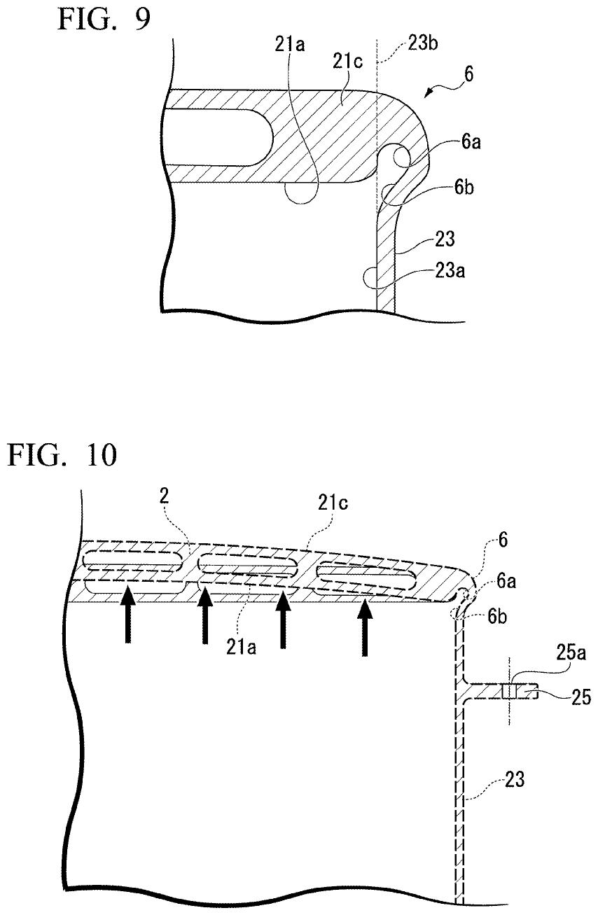

Next, another embodiment of a power storage module according to the present invention will be described. FIG. 7 is a perspective view illustrating a power storage module according to another embodiment of the present invention. FIG. 8 is a cross-sectional view of the power storage module illustrated in FIG. 7 taken along line B-B. FIG. 9 is an enlarged cross-sectional view in which a part of FIG. 8 is enlarged and illustrated.

In a power storage module 10 of a second embodiment illustrated in FIG. 7, members which are the same as those in the power storage module 1 of the first embodiment are denoted by the same references, and a description thereof will be omitted.

Unlike the power storage module 1 of the first embodiment, the partition plate 26 is not provided in the power storage module 10 of the second embodiment as illustrated in FIG. 8. Therefore, in the power storage module 10 of the second embodiment, one cell housing space 28 is disposed between an inner wall surface 21a of a top plate 21c and an inner wall surface 22a of a bottom plate 22 inside a cell housing body 2. In the cell housing space 28 of the power storage module 10 of the second embodiment, as illustrated in FIGS. 7 and 8, three power storage cells 3, an elastic member 4, three power storage cells 3, an elastic member 4, three power storage cells 3, an elastic member 4, and three power storage cells 3 are housed in a stacked state in this order.

Also, as illustrated in FIGS. 8 and 9, in the power storage module 10 of the second embodiment and the power storage module 1 of the first embodiment, connecting portions 6 connecting the top plate 21c and the bottom plate 22 to the two side plates 23 and 23 are different from each other. In the power storage module 10 of the second embodiment, the connecting portions 6 are provided on a side outward from extended surfaces 23b of inner wall surfaces 23a of the side plates 23 and 23.

As illustrated in FIGS. 8 and 9, the inner wall surface 21a of the top plate 21c and the inner wall surface 23a of the side plate 23 are in contact with each other in a connecting groove 6b. Similarly, the inner wall surface 22a of the bottom plate 22 and the inner wall surface 23a of the side plate 23 are in contact with each other in the connecting groove 6b.

The connecting groove 6b is provided to extend in a length direction (D2 direction) of the cell housing body 2 (see FIGS. 7 and 8). As illustrated in FIG. 9, a bottom surface 6a of the connecting groove 6b is provided at a position on a side outward from the extended surface 23b of the inner wall surface 23a of the side plate 23 and a position on a side outward from an extended surface of the inner wall surface 21a of the top plate 21c. The bottom surface 6a of the connecting groove 6b is formed in an arcuate curved surface in a cross-sectional view.

An inner surface of the connecting groove 6b is preferably a curved surface in a cross-sectional view as illustrated in FIG. 9. When the inner surface of the connecting groove 6b is a curved surface in a cross-sectional view, a stress acting on the cell housing body 2 can be more effectively alleviated by the connecting portion 6, and thereby deformation of the cell housing body 2 can be further curbed.

In the power storage module 10 of the second embodiment, unlike the power storage module 1 of the first embodiment, positions in a height direction of the cell housing body 2 at which flange portions 25 and 25 are provided are positions on the side plates 23 and 23 close to the top plate 21c as illustrated in FIG. 7 and FIG. 8.

In the power storage module 10 of the second embodiment, the positions in the height direction of the cell housing body 2 at which the flange portions 25 and 25 are provided are preferably close to the connecting portions 6. That is, as illustrated in FIGS. 7 and 8, the flange portions 25 and 25 are preferably provided at positions on the side plates 23 and 23 close to the top plate 21c or at positions on the side plates 23 and 23 close to the bottom plate 22.

In the vicinity of the connecting portions 6, deformation of the side plates 23 and 23 according to the expansion of the power storage cells 3 is effectively curbed. Therefore, for example, even when the side plates 23 and 23 are deformed according to the expansion of the power storage cells 3, amounts of deformation in the vicinity of the connecting portions 6 are smaller than those in the vicinity of the centers of the side plates 23 and 23 in the height direction of the cell housing body 2. Also, since the rigidity is high in the vicinity of the positions on the side plates 23 and 23 at which the flange portions 25 and 25 are provided due to the provided flanges 25 and 25, deformation of the side plates 23 according to the expansion of the power storage cells 3 does not easily occur. Therefore, when positions in the height direction of the cell housing body 2 at which the flange portions 25 and 25 are provided are close to the connecting portions 6, a synergistic effect in curbing deformation of the side plates 23 is obtained by the connecting portions 6 and the flange portions 25 and 25. Therefore, the deformation curbing effect of the side plates 23 at the positions in which the flange portions 25 and 25 are provided is more significant.

Also, the top plate 21c of the power storage module 10 of the second embodiment as illustrated in FIGS. 7 and 8 is different from that (denoted as reference 21 in the power storage module 1) in the power storage module 1 of the first embodiment illustrated in FIGS. 1 and 2. In the power storage module 10 of the second embodiment, the same one as the bottom plate 22 is provided as the top plate 21c.

In the power storage module 10 of the second embodiment, when the top plate 21c is formed of a metal plate, the top plate 21c functions as a heat dissipation plate. Similarly to the bottom plate 22, one or more holes 53b extending in a direction substantially perpendicular to a thickness direction (D3 direction) are preferably provided inside the top plate 21c. Thereby, a heat dissipation performance of the top plate 21c is further improved, and further reduction in weight of the power storage module 10 can be achieved. In the present embodiment, as illustrated in FIG. 7 and FIG. 8, six holes 53b having substantially an oval shape in a cross-sectional view, in which a dimension of the holes in the thickness direction (D3 direction) of the top plate 21c is smaller than a dimension of the holes in a surface direction (D1 direction) of the top plate 21c, are provided to extend in the length direction (D2 direction) of the cell housing body 2. In the present embodiment, since the holes 53b of the top plate 21c extend in the D2 direction as in the holes 52b of the bottom plate 22, the top plate 21c and the bottom plate 22 can be molded by a method of impact molding or extrusion molding in the D2 direction as parts of the cell housing body 2, and thus this is desirable.

In the power storage module 10 of the present embodiment, the connecting portions 6 connecting the top plate 21c and the bottom plate 22 to the two side plates 23 and 23 are respectively provided on a side outward from the extended surfaces 23b of the inner wall surfaces 23a of the side plates 23 and 23. Therefore, as described below, even when the power storage cells 3 disposed in the cell housing body 2 expand, the cell housing body 2 is not easily deformed. Therefore, in the power storage module 10 of the present embodiment, work of removing the power storage module 10 from an installation site and then fixing it thereto again can be easily performed.

FIG. 10 is an enlarged cross-sectional view illustrating a part of a cut surface of the power storage module illustrated in FIG. 7 taken along line B-B and is an explanatory view showing a state of the cell housing body when the power storage cells expand in the cell housing space.

When the power storage cells 3 disposed in the cell housing body 2 expand due to charging and discharging, the inner wall surface 21a of the top plate 21c is pushed outward (upward in FIG. 10) and the top plate 21c is deformed in a convex shape as illustrated by a dotted line in FIG. 10. Due to the convex deformation of the top plate 21c, a first deforming force caused by a couple of forces of deforming the side plate 23 toward the inside with the vicinity of the connecting portion 6 as a center acts on the side plate 23. Also, due to the expansion of the power storage cells 3, a reaction force by which the inner wall surface 21a of the top plate 21c is pushed outward (upward in FIG. 10) is also generated. In the power storage module 10 illustrated in FIG. 7, the connecting portions 6 connecting the top plate 21c and the bottom plate 22 to the two side plates 23 and 23 are respectively provided on a side outward from the extended surfaces 23b of the inner wall surfaces 23a of the side plates 23 and 23. Therefore, due to the reaction force described above, a second deforming force caused by a couple of forces of deforming the side plates 23 toward the outside with the vicinity of the connecting portion 6 as a center acts. As a result, in the power storage module 10 illustrated in FIG. 7, the first deforming force is canceled out by the second deforming force. Therefore, in the power storage module 10 illustrated in FIG. 7, the cell housing body 2 is not easily deformed even when the power storage cells 3 expand.

Further, in the power storage module 10 illustrated in FIG. 7, the inner wall surface 21a of the top plate 21c and the inner wall surface 23a of the side plate 23, and the inner wall surface 22a of the bottom plate 22 and the inner wall surface 23a of the side plate 23 are respectively in contact with each other in the connecting grooves 6b as illustrated in FIGS. 8 and 9. Then, the bottom surface 6a of the connecting groove 6b is provided at a position on a side outward from the extended surface 23b of the inner wall surface 23a of the side plate 23 and a position on a side outward from extended surface of the inner wall surface 21a of the top plate 21c or the inner wall surface 22a of the bottom plate 22. Therefore, a stress acting on the side plates 23 due to the convex deformation of the top plate 21c and/or the bottom plate 22 is effectively alleviated. Therefore, in the power storage module 10 illustrated in FIG. 7, the cell housing body 2 is hardly deformed even when the power storage cells 3 expand.

### Other Examples

While embodiments of the present invention have been described above, various modifications can be made in design within the scope not departing from the gist of the present invention.

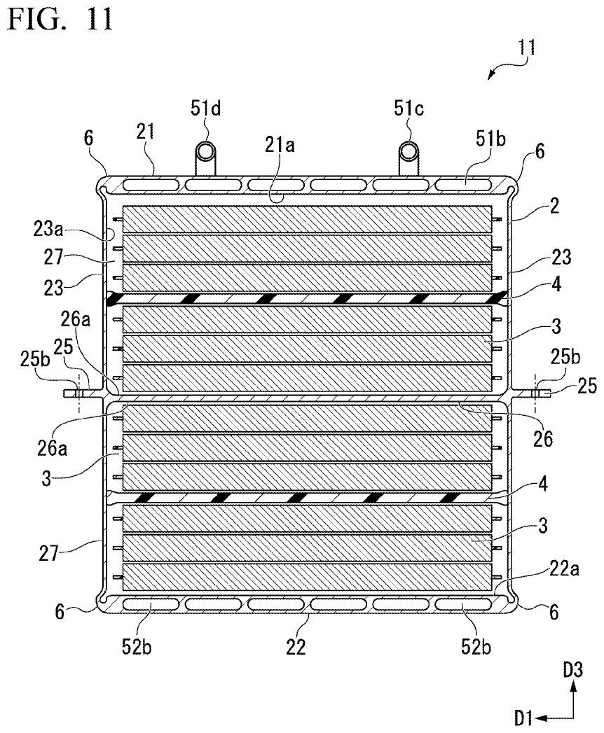

FIG. 11 is a cross-sectional view illustrating a power storage module according to another embodiment of the present invention.

A power storage module 11 illustrated in FIG. 11 employs the connecting portions 6 of the power storage module 10 of the second embodiment, which is provided on a side outward from the extended surfaces 23b of the inner wall surfaces 23a of the side plates 23 and 23, in place of the connecting portions connecting the top plate 21 and the bottom plate 22 to the two side plates 23 and 23 in the power storage module 1 of the first embodiment. Therefore, in the power storage module 11 illustrated in FIG. 11, similarly to the power storage module 10 of the second embodiment, the inner wall surface 21a of the top plate 21 and the inner wall surface 23a of the side plate 23 are in contact with each other in the connecting groove 6b. Similarly, the inner wall surface 22a of the bottom plate 22 and the inner wall surface 23a of the side plate 23 are in contact with each other in the connecting groove 6b.

In the power storage module 11 illustrated in FIG. 11, members which are the same as those in the power storage module 1 of the first embodiment or the power storage module 10 of the second embodiment are denoted by the same references, and a description thereof will be omitted.

The power storage module 11 illustrated in FIG. 11 includes the partition plate 26 provided in the cell housing body 2 to connect the two side plates 23 and 23, and furthermore, the connecting portions 6 connecting the top plate 21 and the bottom plate 22 to the two side plates 23 and 23 are provided on a side outward from the extended surfaces 23b of the inner wall surfaces 23a of the side plates 23 and 23. Therefore, in the power storage module 11 illustrated in FIG. 11, even when the power storage cells 3 disposed in the cell housing body 2 expand, the cell housing body 2 is not easily deformed. Therefore, in the power storage module 11 illustrated in FIG. 11, work of removing the power storage module 11 from an installation site and then fixing it thereto again can be easily performed.

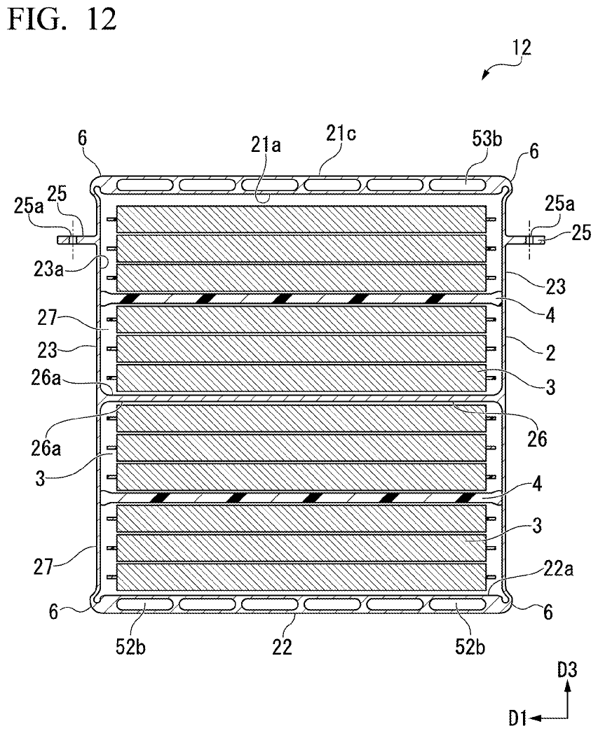

FIG. 12 is a cross-sectional view illustrating a power storage module according to still another embodiment of the present invention.

A power storage module 12 illustrated in FIG. 12 includes the partition plate 26 connecting the two side plates 23 and 23 in the cell housing body 2 of the power storage module 1 of the first embodiment instead of the central elastic member 4 of the three elastic members 4 in the power storage module 10 of the second embodiment.

In the power storage module 12 illustrated in FIG. 12, members which are the same as those in the power storage module 1 of the first embodiment or the power storage module 10 of the second embodiment are denoted by the same references, and a description thereof will be omitted.

As in the power storage module 11 illustrated in FIG. 11, the power storage module 12 illustrated in FIG. 12 includes the partition plate 26 provided in the cell housing body 2 to connect the two side plates 23 and 23, and furthermore, the connecting portions 6 connecting the top plate 21c and the bottom plate 22 to the two side plates 23 and 23 are provided on a side outward from the extended surfaces 23b of the inner wall surfaces 23a of the side plates 23 and 23. Therefore, in the power storage module 12 illustrated in FIG. 12, the cell housing body 2 is not easily deformed even when the power storage cells 3 disposed in the cell housing body 2 expand. Therefore, in the power storage module 12 illustrated in FIG. 12, work of removing the power storage module 12 from an installation site and then fixing it thereto again can be easily performed.

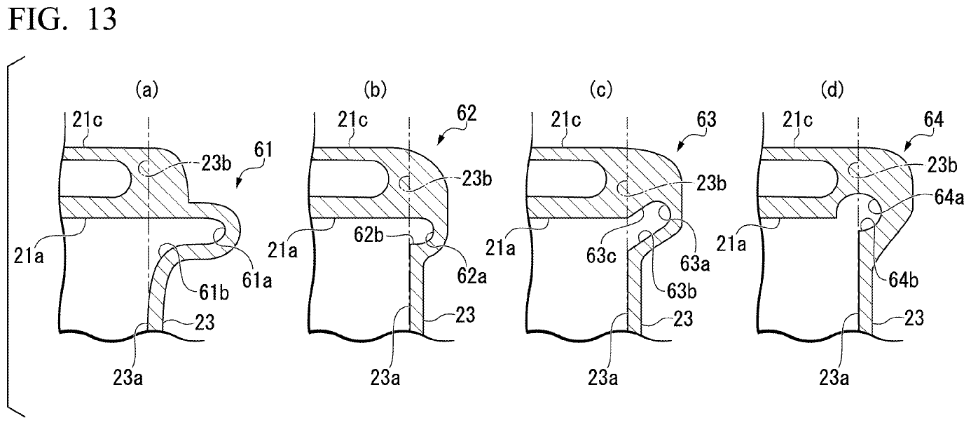

Shapes of the connecting portions 6 in the power storage modules 10, 11, and 12 of the above-described embodiments are not limited to the examples described above. For example, the connecting portion 6 may have cross-sectional shapes illustrated in (a) o (d) of FIG. 13.

As in the connecting portion 6, a connecting portion 61 illustrated in (a) of FIG. 13 is provided on a side outward from the extended surface 23b of the inner wall surface 23a of each of the side plates 23 and 23. The connecting portion 61 includes a connecting groove 61b provided to extend in the length direction (D2 direction) of the cell housing body 2. As illustrated in (a) of FIG. 13, a bottom surface 61a of the connecting groove 61b is provided at a position on a side outward from the extended surface 23b of the inner wall surface 23a of the side plate 23.

A part of an inner surface of the connecting groove 61b is coplanar with the inner wall surface 21a of the top plate 21c. The connecting groove 61b has a shape in which a width thereof gradually decreases from an opening thereof toward the bottom surface 61a. The bottom surface 61a of the connecting groove 61b is formed in a curved surface in a cross-sectional view.

As in the connecting portion 6, a connecting portion 62 illustrated in (b) of FIG. 13 is provided on a side outward from the extended surface 23b of the inner wall surface 23a of each of the side plates 23 and 23. The connecting portion 62 includes a connecting groove 62b provided to extend in the D2 direction. As illustrated in (b) of FIG. 13, a bottom surface 62a of the connecting groove 62b is provided at a position on a side outward from the extended surface 23b of the inner wall surface 23a of the side plate 23. A bottom surface 62a of the connecting groove 62b is formed in a curved surface having a semicircular shape in a cross-sectional view.

Also in the power storage modules having the connecting portions 61 and 62 illustrated in (a) and (b) of FIG. 13, since the connecting portions 61 and 62 are provided on a side outward from the extended surfaces 23b of the inner wall surfaces 23a of the side plates 23 and 23, the cell housing body 2 is not easily deformed even when the power storage cells 3 expand. Also, in the connecting portions 61 and 62 illustrated in (a) and (b) of FIG. 13, the inner wall surface 21a of the top plate 21c and the inner wall surface 23a of the side plate 23, and the inner wall surface 22a of the bottom plate 22 and the inner wall surface 23a of the side plate 23 are in contact with each other in the connecting grooves 61b and 62b, respectively. Then, the bottom surfaces 61a and 62a of the connecting grooves 61b and 62b are each provided at a position on a side outward from the extended surface 23b of the inner wall surface 23a of the side plate 23. Therefore, a stress acting on the side plate 23 due to convex deformation of the top plate 21c and/or the bottom plate 22 is effectively alleviated.

As in the connecting portion 6, a connecting portion 63 illustrated in (c) of FIG. 13 is provided on a side outward from the extended surface 23b of the inner wall surface 23a of each of the side plates 23 and 23. The connecting portion 63 includes a connecting groove 63b provided to extend in the D2 direction. As illustrated in (c) of FIG. 13, a bottom surface 63a of the connecting groove 63b is positioned on a side outward from the extended surface 23b of the inner wall surface 23a of the side plate 23 and is provided at a position on a side outward from extended surface of the inner wall surface 21a of the top plate 21c or the inner wall surface 22a of the bottom plate 22. The connecting groove 63b has wall surfaces 63c parallel to each other between an opening thereof and the bottom surface 63a in a cross-sectional view. The bottom surface 63a of the connecting groove 63b is formed in a curved surface having a semicircular shape in a cross-sectional view.

As in the connecting portion 6, a connecting portion 64 illustrated in (d) of FIG. 13 is provided on a side outward from the extended surface 23b of the inner wall surface 23a of each of the side plates 23 and 23. The connecting portion 64 includes a connecting groove 64b provided to extend in the D2 direction. As illustrated in (d) of FIG. 13, a bottom surface 64a of the connecting groove 64b is positioned on a side outward from the extended surface 23b of the inner wall surface 23a of the side plate 23 and is provided at a position on a side outward from the extended surface of the inner wall surface 21a of the top plate 21c or the inner wall surface 22a of the bottom plate 22. The bottom surface 64a of the connecting groove 64b is formed in a substantially C-shaped arcuate curved surface in a cross-sectional view.

Also in the power storage modules having the connecting portions 63 and 64 illustrated in (c) and (d) of FIG. 13, since the connecting portions 63 and 64 are provided on a side outward from the extended surfaces 23b of the inner wall surfaces 23a of the side plates 23 and 23, the cell housing body 2 is not easily deformed even when the power storage cells 3 expand. Also, in the connecting portions 63 and 64 illustrated in (c) and (d) of FIG. 13, the inner wall surface 21a of the top plate 21c and the inner wall surface 23a of the side plate 23, and the inner wall surface 22a of the bottom plate 22 and the inner wall surface 23a of the side plate 23 are in contact with each other in the connecting grooves 63b and 64b, respectively. Then, the bottom surfaces 63a and 64a of the connecting grooves 63b and 64b are each positioned on a side outward from the extended surface 23b of the inner wall surface 23a of the side plate 23 and are each provided at a position on a side outward from the extended surface of the inner wall surface 21a of the top plate 21c or the inner wall surface 22a of the bottom plate 22. Therefore, a stress acting on the side plate 23 due to convex deformation of the top plate 21c and/or the bottom plate 22 is more effectively alleviated.

Also, in the power storage modules 10, 11 and 12 of the above-described embodiments, a temperature control device such as a water jacket may be provided on the outer surface of the cell housing body 2 (outer surfaces of the top plate 21a, the bottom plate 22, and the side plates 23). As the water jacket, one formed of a hollowed member made of a metal such as aluminum and having a passage through which a refrigerant such as water or cooling air flows formed therein or the like can be used. A heat transfer sheet is preferably disposed between the water jacket and the outer surface of the cell housing body 2. When the temperature control device is provided on the outer surface of the cell housing body 2, the power storage modules 10, 11, and 12 can cool the power storage cells 3 more efficiently.

Although the cases in which 12 power storage cells 3 are housed in the cell housing body 2 have been described as examples in the power storage modules 1, 10, 11, and 12 of the embodiments described above, the number of power storage cells 3 housed in the cell housing body is not limited to 12 and may be 1 to 11 or may be 13 or more.

Although the cases in which the elastic member 4 is disposed in each of the cell housing spaces 27 and 28 have been described as examples in the power storage modules 1, 10, 11, and 12 of the embodiments described above, the number of elastic members 4 disposed in each of the cell housing spaces 27 and 28 is not particularly limited, and the elastic member 4 may not be provided.

As described above, according to the present invention, a power storage module in which the cell housing body is not easily deformed even when the power storage cells disposed in the cell housing body expand can be provided.

### EXPLANATION OF REFERENCES

1, 10, 11, 12 Power storage module

2 Cell housing body

3 Power storage cell

3a Positive electrode terminal

3b Negative electrode terminal

4 Elastic member

6, 61, 62, 63, 64 Connecting portion

6a, 61a, 62a, 63a, 64a Bottom surface

6b, 61b, 62b, 63b, 64b Connecting groove

21, 21c Top plate

21a, 22a, 23a Inner wall surface

22 Bottom plate

23 Side plate

23b Extended surface

24 Opening

25 Flange portion

25a, 25b Attachment portion

26 Partition plate

26a Wall surface

27, 28 Cell housing space

51a Sealing plate

51b Refrigerant flow path

52b, 53b Hole

51c Inlet port

51d Discharge port

63c Wall surface

What is claimed is:

1. A power storage module comprising:
a cell housing body including:
a rectangular top plate and bottom plate; and
two rectangular side plates disposed to face each other to connect the top plate and the bottom plate;
a plurality of cell housing spaces disposed in the cell housing body and separated by a partition plate connecting the two side plates;
a power storage cell housed in the cell housing spaces; and
plate-shaped flange portions formed to protrude from outer surfaces of the two side plates,
wherein the power storage module is fixable to an installation site by fixing the plate-shaped flange portions to the installation site.

2. A power storage module comprising:
a cell housing body including:
a rectangular top plate and bottom plate; and
two rectangular side plates disposed to face each other to connect the top plate and the bottom plate;
a cell housing space disposed in the cell housing body;
a power storage cell housed in the cell housing space; and
plate-shaped flange portions formed to protrude from outer surfaces of the two side plates, wherein
connecting portions connecting the top plate and the bottom plate to the two side plates are each provided on a side outward from an extended surface of an inner wall surface of each of the side plates, and
the power storage module is fixable to an installation site by fixing the plate-shaped flange portions to the installation site.

3. The power storage module according to claim 1, wherein
the flange portions are disposed parallel to the top plate and the bottom plate over an entire length of the side plates in a length direction, and
attachment portions which fix the flange portions to the installation site are provided at a plurality of positions in an extending direction of the flange portions.

4. The power storage module according to claim 1, wherein the cell housing body is an integrally molded product which is formed by impact-molding or extrusion-molding a metal material.

5. The power storage module according to claim 1, wherein a sheet-shaped elastic member is disposed in the cell housing space together with the power storage cell.

6. The power storage module according to claim 5, wherein
the sheet-shaped elastic member includes:
an elastic body or a structure body having expansibility; and
a housing bag in which the elastic body or the structure body having expansibility is housed, and
the housing bag is formed of a metal foil composite laminate film.

7. The power storage module according to claim 1, wherein one or both of the top plate and the bottom plate include a refrigerant flow path in which a refrigerant flows.

8. The power storage module according to claim 7, wherein
the cell housing body includes two openings surrounded by the top plate, the bottom plate, and the two side plates,
an inlet port for injecting the refrigerant into the refrigerant flow path and a discharge port for discharging the refrigerant that has passed through the refrigerant flow path are provided in the vicinity of one of the two openings, and
a positive electrode terminal and a negative electrode terminal of the power storage cell are disposed at one of the two openings which is distant from the inlet port and the discharge port.

9. The power storage module according to claim 1, wherein the power storage cell is a cell which is formed by enclosing a battery element in a laminate film.

10. The power storage module according to claim 1, wherein a plurality of power storage cells are disposed to be stacked between the top plate and the bottom plate.

11. The power storage module according to claim 1, wherein connecting portions connecting the top plate and the bottom plate with the two side plates are each provided on a side outward from an extended surface of an inner wall surface of each of the side plates.

12. The power storage module according to claim 2, wherein
the flange portions are disposed parallel to the top plate and the bottom plate over an entire length of the side plates in a length direction, and
attachment portions which fix the flange portions to the installation site are provided at a plurality of positions in an extending direction of the flange portions.

13. The power storage module according to claim 2, wherein the cell housing body is an integrally molded product which is formed by impact-molding or extrusion-molding a metal material.

14. The power storage module according to claim 2, wherein a sheet-shaped elastic member is disposed in the cell housing space together with the power storage cell.

15. The power storage module according to claim 14, wherein
the sheet-shaped elastic member includes:
an elastic body or a structure body having expansibility; and
a housing bag in which the elastic body or the structure body having expansibility is housed, and
the housing bag is formed of a metal foil composite laminate film.

16. The power storage module according to claim 2, wherein one or both of the top plate and the bottom plate include a refrigerant flow path in which a refrigerant flows.

17. The power storage module according to claim 16, wherein
the cell housing body includes two openings surrounded by the top plate, the bottom plate, and the two side plates,
an inlet port for injecting the refrigerant into the refrigerant flow path and a discharge port for discharging the refrigerant that has passed through the refrigerant flow path are provided in the vicinity of one of the two openings, and
a positive electrode terminal and a negative electrode terminal of the power storage cell are disposed at one of the two openings which is distant from the inlet port and the discharge port.

18. The power storage module according to claim 2, wherein the power storage cell is a cell which is formed by enclosing a battery element in a laminate film.

19. The power storage module according to claim 2, wherein a plurality of power storage cells are disposed to be stacked between the top plate and the bottom plate.

20. The power storage module according to claim 2, wherein the cell housing space is a plurality of cell housing spaces which are disposed in the cell housing body and separated by a partition plate connecting the two side plates.
